(19) United States
(12) Patent Application Publication
(10) Pub. No.: US 2011/0107619 A1
(43) Pub. Date: May 12, 2011

(54) Removable Eyelet Outer Rings for Footwear

(75) Inventors: George Esquivel, Buena Park, CA (US); Dana B. Robinson, La Jolla, CA (US)

(73) Assignee: ESQUIVEL DESIGNS LLC, Buena Park, CA (US)

(21) Appl. No.: 12/614,199

(22) Filed: Nov. 6, 2009

(51) Int. Cl. A43C 11/00; F16C 33/04; B25B 13/02

(52) U.S. Cl. 36/50.1; 16/2.1; 81/119

(57) ABSTRACT

An eyelet outer ring assembly for use with footwear having a base member and various sized, shaped, and ornamentally designed detachable outer eyelet ring with attachment means permanently connected to either base member and/or outer eyelet ring that are detachably secured. Base member and/or eyelet outer ring attachment means protrude partially or fully through eyelet holes of footwear. Each outer eyelet ring may contain functional grooved configurations to accommodate various fastening tool's prong or prongs and may be placed in an ornamentally desired manner. A fastening tool with a handle is used to create torque for fastening said base member and outer eyelet ring. In desirable instances, the fastening tool's prong or prongs are made of or coated with material that is durable but will not harm or scratch said eyelet assemblies.

### CROSS REFERENCE TO RELATED APPLICATIONS

Not applicable

### STATEMENT REGARDING FEDERALLY SPONSORED RESEARCH OR DEVELOPMENT

Not applicable

### REFERENCE TO SEQUENCE LISTING, A TABLE, OR A COMPUTER PROGRAM LISTING COMPACT DISK APPENDIX

Not applicable

### BACKGROUND OF THE INVENTION

1. Field of the Invention

This invention relates to an article of removable eyelet outer rings for footwear.

2. Background Art

Articles of footwear, which include: shoes, sneakers, boots, and sandals; often include eyelet outer rings. Eyelet outer rings are visible from the outside of the article of footwear. They are not necessarily circular, nor are they necessarily continuous. For example, an eyelet outer ring can be an open semi-circle, appear hook shaped, or can be square. Eyelet outer rings serve a practical purpose of guiding a lace through a shoe and can be ornamental.

U.S. Pat. No. 794,838 discloses eyelet outer rings that are permanently attached to a shoe. They eyelet outer rings of the '838 patent allow the laces to secure the footwear to the user's feet. They are durable and resistant to wear. One of the shortcomings of the outer rings disclosed in the '838 patent is that they cannot be easily removed or interchanged.

U.S. Pat. No. 4,414,761 discloses a shoe having a plurality of eyelet outer rings attached to a sheet material with VELCRO underneath. Although the eyelet outer rings of the '761 patent can be removed, the design has its shortcomings. The VELCRO™ attachment can become loose. The sheet of material that the eyelet outer rings of the '761 patent are attached to may also be aesthetically undesirable.

U.S. Pat. No. 6,568,104 also discloses a removable eyelet outer ring. The eyelet outer rings in the '104 patent are removable. A user of the shoe disclosed in the '104 patent could not remove all of the eyelet outer rings.

U.S. Pat. No. 4,125,918 discloses a fastener for shoe laces. The fastener in the '918 patent has the advantage of having an outer visible member that can be easily removed. Shoe laces in the '918 patent go around the disclosed fastener rather than through the eyelet outer rings. The fastener in the '918 patent can be easily deformed over time by the tension of the laces. The laces can also slip of the '918 fastener if they become loose, if the laces are thick relative to the size of the fastener, or by a combination of thick and loose laces. Large outer visible members, that are necessary to secure the laces, may be undesirable because they cost more or may be aesthetically undesirable.

The current invention discloses eyelet outer rings that do not have the limitations of the prior art. The eyelet outer rings can be easily removed from or added to footwear. This is advantageous because the user can replace outer rings when they become damaged or worn. This is also advantageous because the user may wish to wear one type of eyelet outer ring on one occasion, and a different type of eyelet outer ring on a different occasion. For example, a user may wear an eyelet outer ring decorated with jewels or other ornamentation to a social function and may wish to wear an eyelet outer ring made of inexpensive material while walking on the street. Additionally, a user may add the removable eyelet outer rings to footwear already containing or lacking eyelet outer rings, as desired. For example, a user's footwear may not contain eyelet outer rings and the user may wish to protect the holes through which the laces are passed through from wear or the user may wish to add ornamental eyelet outer rings to said footwear.

The eyelet outer rings also allow for the laces to secure the footwear to the users' feet. The laces are less likely to slip off or detach from the claimed removable eyelet outer rings compared to other prior art eyelet outer rings. Furthermore, the outer rings can achieve a secure fit without using large amounts of material.

### BRIEF SUMMARY OF THE INVENTION

Accordingly, it is the principal object of this invention to provide footwear with the ability to easily remove or add the user's desired number of eyelet outer rings that achieve a secure fit to the user's feet, which can be durable and/or aesthetically and practically desirable as determined by the user for different situations.

A further object of this invention is to provide user specified or desired eyelet outer rings which are adapted for ease of installation and removal on existing pairs of shoes with and without shoelace eyelets or which may be readily installed by a shoe manufacturer in lieu of non-removable eyelet outer rings as an original footwear installation.

The claimed invention describes removable eyelet outer rings for use with footwear. Footwear with removable eyelet outer rings offers numerous advantages over the prior art including the ability to be easily removed and exchanged when desired by the wearer. The invention also has the advantage of achieving a more secure fit of the footwear to the user's feet coupled with less likelihood of detachment of the laces compared to the prior art. Furthermore, many shoes on the market are sold without eyelet outer rings and merely contain holes through which the laces are passed through. The claimed removable eyelet outer rings offer the user the advantage of adding eyelet outer rings to the said footwear when desired. For example, a user may desire to add ornamentation or to achieve better protection from wear of the holes through which the laces are passed through.

### BRIEF DESCRIPTION OF THE DRAWINGS

FIG. 1 shows an article of footwear containing with eyelet outer rings.

FIGS. 2, 3, 4, and 5 show different embodiments of an eyelet outer ring assembly.

FIG. 6 depicts an eyelet outer ring assembly in an article of footwear.

FIGS. 7 and 8 depict eyelet outer ring assemblies in an article of footwear with a shoelace.

FIGS. 9 and 10 depict an eyelet outer ring assembly with an eyelet outer ring tool

### DETAILED DESCRIPTION OF THE DRAWINGS

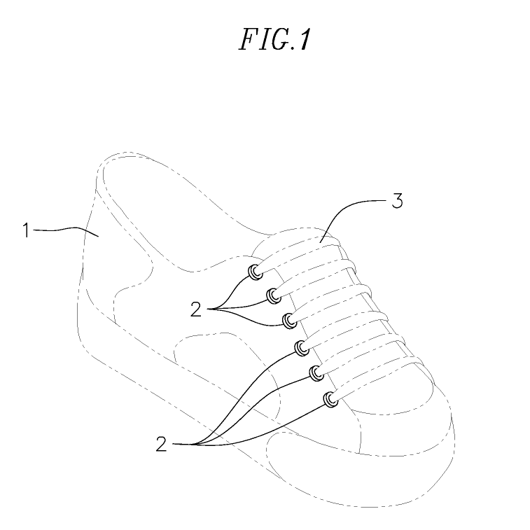

FIG. 1 shows an article of footwear 1 with eyelet outer rings 2. The shoelace, 3, is threaded through the eyelet outer rings 2.

FIG. 2 shows one embodiment of an eyelet outer ring assembly 6a. The assembly comprises of: an eyelet outer ring 2 and a base member 4. The attachment means are a screw 5b permanently attached to base member 4 and threads 5a in eyelet outer ring 2 to receive said screw 5b.

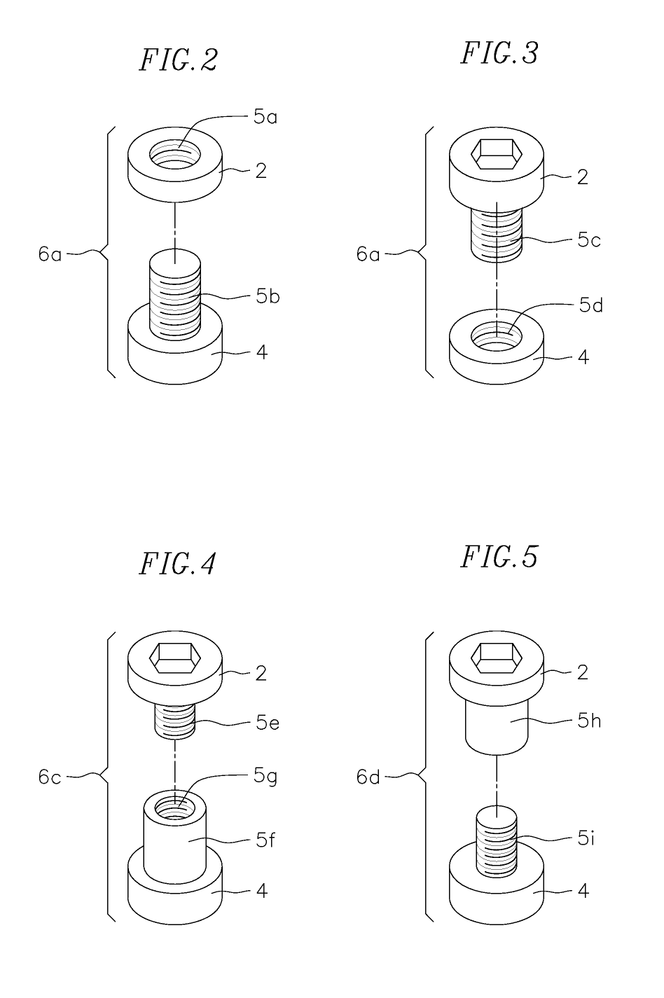

FIG. 3 shows another embodiment of an eyelet outer ring assembly 6b. The assembly comprises of: an eyelet outer ring 2 and a base member 4. The attachment means are a screw 5c permanently attached to eyelet outer ring 2 and threads 5d in base member 4 to receive said screw 5c.

FIG. 4 shows yet another embodiment of an eyelet outer ring assembly 6c. The assembly comprises of: an eyelet outer ring 2 and a base member 4. The attachment means are a screw 5e permanently attached to eyelet outer ring 2 and a screw receiving member 5f with threads 5g. Receiving member 5f is permanently attached to base member 4 and receives screw 5e.

FIG. 5 depicts another embodiment of an eyelet outer ring assembly 6d. The assembly comprises of an eyelet outer ring 2 and a base member 4. The attachment means are a screw 5i permanently attached to base member 4 and screw receiving member 5h permanently attached to eyelet outer ring 2 to receive said screw 5i.

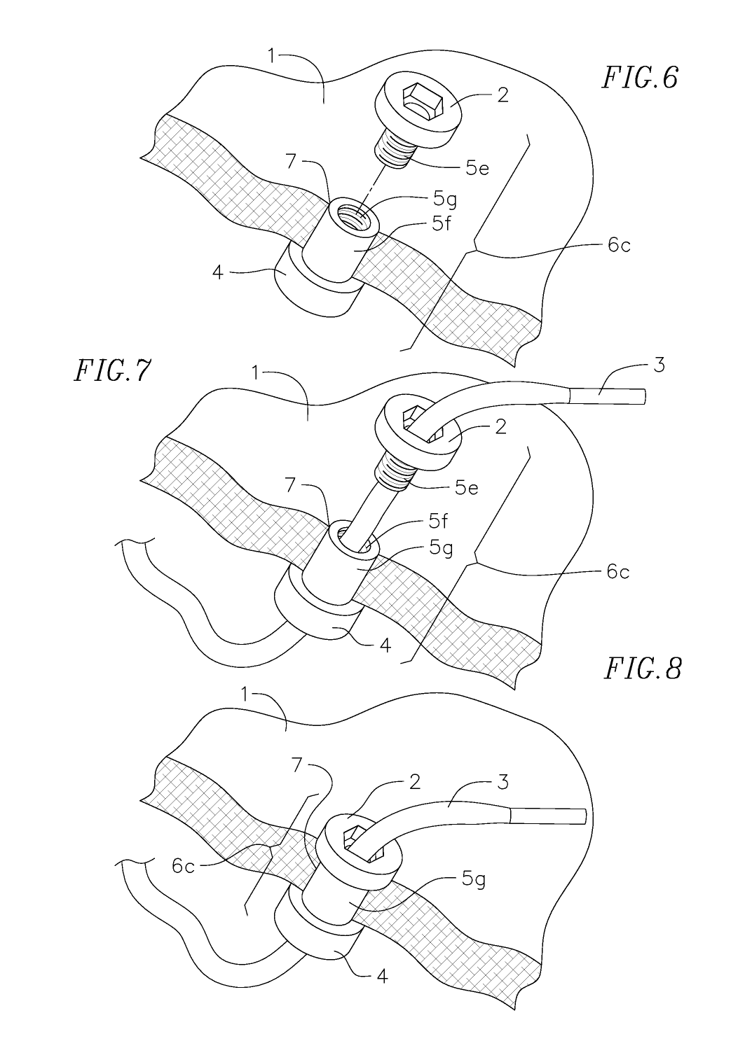

FIG. 6 depicts an eyelet outer ring assembly, more specifically eyelet outer ring assembly 6c, in an article of footwear 1. Base member 4 resides beneath article of footwear 1. The attachment means, screw receiving member 5g protrudes into eyelet hole 7 of shoe 1. Screw 5e, which it attached to eyelet outer ring 2 protrudes into eyelet hole 7 and attaches to screw 5e within eyelet hole 7 of shoe 1.

FIG. 7 depicts an eyelet outer ring assembly, more specifically eyelet outer ring assembly 6c, in an article of footwear 1 with a shoelace 3. Base member 4 resides beneath article of footwear 1. The attachment means, screw receiving member 5g protrudes into eyelet hole 7 of shoe 1. Screw 5e, which it attached to eyelet outer ring 2 protrudes into eyelet hole 7 and attaches to screw 5e within eyelet hole 7 of shoe 1. Shoelace 3 is threaded through eyelet outer ring 2, goes through screw 5e, screw receiving member 5g, and base member 4.

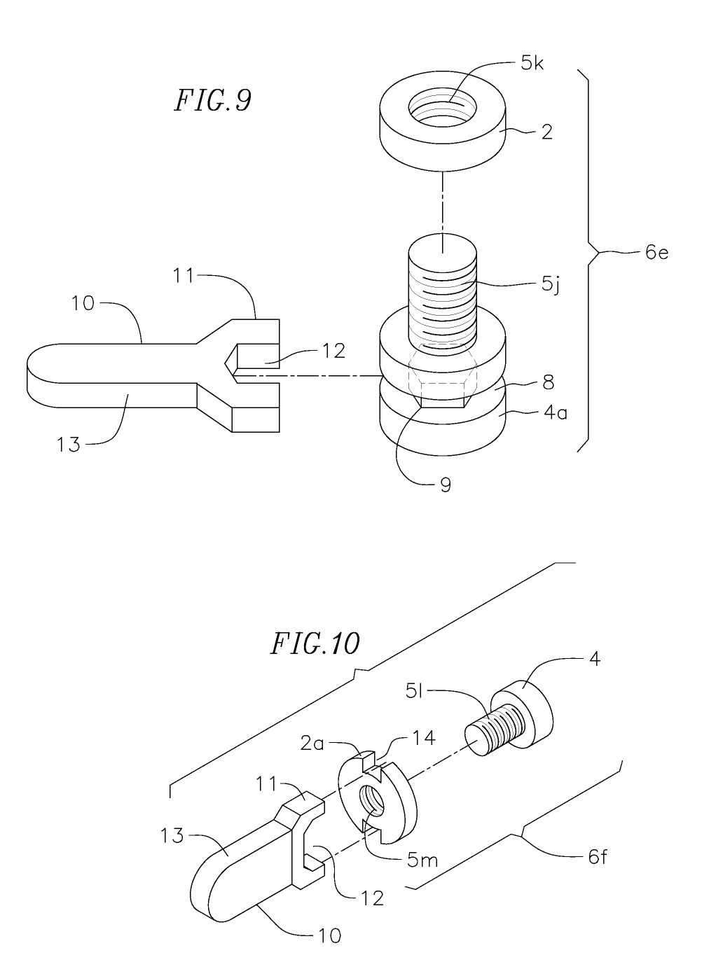

FIG. 8 depicts an eyelet outer ring assembly, more specifically eyelet outer ring assembly 6c in an article of footwear 1 with a shoelace 3. Base member 4 resides beneath article of footwear 1. The attachment means, screw receiving member 5g and screw 5e (not shown) protrude into eyelet hole 7 of shoe 1. The shoelace 3 is threaded through eyelet outer ring 2, goes through screw 5e and screw receiving member 5g and base member 4.

FIG. 9 depicts an eyelet outer ring assembly, 6e, with an eyelet outer ring tool 10. The eyelet outer ring assembly 6e assembly comprises of: an eyelet outer ring 2 and a base member 4a. The attachment means are a screw 5j permanently attached to base member 4a and threads 5k in eyelet outer ring 2 to receive screw 5k. Base member 4a has a groove 8 to accommodate eyelet outer ring tool 10 and insert 9, which has at least 2 flat surfaces for eyelet outer ring tool prongs 11 to grip. The eyelet outer ring tool 10 is comprise of gripping prongs 11, a groove 12 to accommodate insert 9 and a handle 13.

FIG. 10 depicts an eyelet outer ring assembly 6f, with an eyelet outer ring tool 10. The eyelet outer ring assembly comprises a base member 4, a screw 5l permanently attached to said base member, an eyelet outer ring 2a, and threads 5m for receiving screw 5l. Eyelet outer ring 2a has grooves 14 that the outer ring tool prongs 11 can fit into. The eyelet outer ring tool is comprised of gripping prongs 11, a groove 12 to accommodate eyelet outer ring 2a and a handle 13.

### DESCRIPTION OF PREFERRED EMBODIMENTS

A preferred embodiment is depicted in FIG. 10. It is comprised of base member 4, permanently connected to screw 5l. Outer eyelet ring 2a detachably connects to base member 4 via screw 5l. Outer eyelet ring contains grooves 14 to accommodate the prongs 11 of the eyelet outer ring tool 10. The grooves 14 can run perpendicular to the face of the outer eyelet ring as depicted in FIG. 10, or can run parallel and underneath the face of the outer eyelet ring so as to be concealed when one looks down upon the outer eyelet ring.

Although the embodiments depicted in FIGS. 2-10 show attachment means consisting of screws and threaded receiving means for the screws, the invention as claimed is not limited to attachment means consisting of screws. The claimed invention includes buttons, hook and eye attachments, clasps, and other equivalent means that could detachably secure the two parts of the eyelet outer ring assemblies.

I claim:

1. An eyelet outer ring assembly comprising a base member, an attachment means permanently connected to said base member, and an eyelet outer ring that detachably, secures to said attachment means.

2. An eyelet outer ring assembly of claim 1 where said base member can attach to a plurality of eyelet outer rings of all shapes and sizes.

3. An article of footwear comprising of an eyelet hole, a base member underneath said eyelet hole, an attachment means permanently attached to said base member that protrudes completely through said eyelet hole, and an eyelet outer ring detachably secured to said attachment means.

4. An eyelet outer ring assembly comprising a base member, an eyelet outer ring, an attachment means permanently connected to said eyelet outer ring, where said attachment means detachably secures to said base member.

5. An article of footwear comprising an eyelet hole, a base member underneath said eyelet hole, an eyelet outer ring, an attachment means permanently connected to said eyelet outer ring, where said attachment means connects to said base member by protruding completely through said eyelet hole

6. An eyelet outer ring assembly comprising a base member, an eyelet outer ring, attachment means permanently connected to said base member, attachment means permanently connected to said eyelet outer ring, where said base member and said eyelet outer ring detachably secure to one another via their attachment means.

7. An article of footwear comprising an eyelet hole, a base member underneath said eyelet hole, an eyelet outer ring, an attachment means permanently connected to said eyelet outer ring that partially protrudes into said eyelet hole, an attachment means permanently connected to said base member that partially protrudes into said eyelet hole, where said base member and said eyelet outer ring detachably secure to one another via their attachment means.

8. An eyelet outer ring assembly as described in claim 1, 2, 4, or 6 that has a grooved configuration in the eyelet outer ring to accommodate the prong or prongs of a fastening tool.

9. An eyelet outer ring assembly as in claim 8 that has a grooved configuration in the base member to accommodate the prong or prongs of a fastening tool and an insert with at least one flat side for the prong or prongs of the fastening tool to grip.

10. An eyelet outer ring assembly as in claim 8 where the grooved configuration in the eyelet outer ring assembly has an irregular shape so as to accommodate the irregularly shaped prong or prongs of a fastening tool.

11. An eyelet outer ring assembly as in claim 10 that has a grooved configuration in the base member to accommodate the prong or prongs of a fastening tool and an insert with at least one flat side for the prong or prongs of the fastening tool to grip.

12. An eyelet outer ring assembly as described in claim 1, 2, 4, or 6 that has a grooved configuration in the eyelet outer ring to accommodate the prong or prongs of a fastening tool, where said grooved configuration is underneath the face of the eyelet outer ring so that it is not visible from one looking down on the eyelet outer ring.

13. An eyelet outer ring assembly as in claim 12 where the grooved configuration in the outer ring assembly has an irregular shape so as to accommodate the irregularly shaped prong or prongs of a fastening tool.

14. An eyelet outer ring assembly as in claim 12 that has a grooved configuration in the base member to accommodate the prong or prongs of a fastening tool and an insert with at least one flat side for the prong or prongs of the fastening tool to grip.

15. An eyelet outer ring assembly as in claim 1, 2, 4 or 6 that has a grooved configuration in the base member to accommodate the prong or prongs of a fastening tool and an insert with at least one flat side for the prong or prongs of the fastening tool to grip.

16. A tool for securing eyelet outer rings to base members comprising of a handle and one or more prongs protruding from said handle.

17. A tool as in claim 16 where said prong or prongs have an irregular shape.

18. A tool as in claim 16 or 17, where said prong or prongs are made of plastic, Teflon, rubber or some other durable yet soft surface that will not scratch eyelet assemblies.

19. A tool as in claim 16 or 17, where said prong or prongs are coated with plastic, Teflon, rubber or some other durable, yet soft surface that will not scratch eyelet assemblies.
